(19) United States
(12) Patent Application Publication
(10) Pub. No.: US 2011/0307432 A1
(43) Pub. Date: Dec. 15, 2011

(54) RELEVANCE FOR NAME SEGMENT SEARCHES

(75) Inventors: QI YAO, SAMMAMISH, WA (US); VINCENT LI, BEIJING (CN); JUNBIAO TANG, BEIJING (CN); RICHARD CHANG, BEIJING (CN)

(73) Assignee: MICROSOFT CORPORATION, REDMOND, WA (US)

(21) Appl. No.: 12/813,813

(22) Filed: Jun. 11, 2010

(51) Int. Cl. G06F 17/30; G06N 3/08

(52) U.S. Cl. 706/25; 707/741; 707/723; 707/706; 707/E17.002; 707/E17.108

(57) ABSTRACT

Improved search result relevance is provided for name segment searches performed by a general web search engine. Entity-related information is mined from web documents and search engine query logs, and metadata is indexed in a search system index. The metadata may include information identifying entity homepages, entity web pages at high quality top sites, other entity-related web pages, entity equivalent data, and/or entity misspellings data. The indexed metadata is employed to provide improved search results relevance for search queries that include an entity's name by improving the ranking of search results corresponding with entity-relevant web pages.

### BACKGROUND

The amount of information and content available on the Internet continues to grow exponentially. Given the vast amount of information, search engines have been developed to facilitate web searching. In particular, end users may search for information and documents by entering search queries comprising one or more terms that may be of interest to the end users. After receiving a search query from an end user, a search engine identifies documents and/or web pages that are relevant based on the terms. Because of its utility, web searching, that is, the process of finding relevant web pages and documents for user issued search queries, has arguably become the most popular service on the Internet today.

End users often employ search engines to search for web documents corresponding with particular entities of interest to end users. For instance, end users may search for information on individuals, music bands, movies, and other entities. When an end user is searching for information regarding a particular entity, the end user may enter some variation of the entity's name as the search query. This is referred to herein as a “name search query.” In some instances, a name search query may include only the entity's name, while in other instances, a name search query may include the entity's name with other search terms.

When an end user enters a name search query, the end user may often be seeking the entity's homepage or would like to find information on the entity from a popular website, such as WIKIPEDIA. However, when the end user enters a name search query to a general web search engine, search results corresponding with the entity's homepage, a web page for the entity at a popular website, or other web pages that may be highly relevant to the entity may not be ranked near the top of the search results list or may not be included in the search results list at all. As a result, end users may need to sift through the search result list to find these items or simply may not find them in the search results list.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing improved search result relevance for name search queries. Web documents and search engine query logs are mined for entity-related information, and entity-related metadata is indexed in a search system index. The entity-related metadata may identify entity homepages, entity web pages at high quality top sites, other entity-related web pages, entity name equivalents, and/or entity name misspellings. When a search query is received, query classification may be used to identify the search query as a name search query containing an entity name. Based on such query classification, entity-related metadata is used to provide improve search result rankings to entity-relevant web documents.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram showing a system for providing search results to name search queries in accordance with an embodiment of the present invention;

FIG. 3 is a flow diagram showing a method for identifying a web page as the homepage of an entity in accordance with an embodiment of the present invention;

FIG. 4 is a flow diagram showing a method for identifying a web page of an entity at a high quality top site in accordance with an embodiment of the present invention;

FIG. 5 is a flow diagram showing a method for identifying web pages associated with an entity based on analysis of search engine query logs in accordance with an embodiment of the present invention;

FIG. 6 is a flow diagram showing a method for performing a name segment search in accordance with an embodiment of the present invention; and

FIG. 7 is a flow diagram showing a method for building a ranking model based on names metadata in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to improving the relevance of search results to name search queries. As noted above, when an end user enters a name search query to a general web search engine, the end user often would like to find an entity's homepage, web pages discussing the entity at high quality top sites, and other web pages that are particularly relevant to the entity. Embodiments of the present invention provide techniques for improving the ranking of such web pages as search results to name search queries.

Embodiments of the present invention include a document understanding portion that operates to identify entities' homepages, web pages discussing entities at high quality top sites, and other web pages deemed to be highly relevant to entities. Metadata is indexed into a search system index to facility returning the entities' homepages, high quality top site web pages, and other entity-relevant web pages in response to name search queries.

As used herein, the term “homepage” refers to an entity's personal web page or the main web page of an entity's personal website. For instance, individuals often have homepages that include personal information, photographs, or other information important to the individuals. As another example, music bands often maintain homepages that include information regarding the bands, such as band history, tour dates, band news, and other information regarding the bands.

As used herein, the term “high quality top site” refers to a web site that is considered to have high quality and reliable information for different entities. As is known in the art, a web site is a collection of web pages, often with each web page sharing the same domain name. Each high quality top site includes a number of web pages with each web page discussing a particular entity or topic. For instance, a high quality top site may be an encyclopedia, a social networking site, an employer's website, or other web site that contains a collection of web pages directed to different entities. By way of specific example only, high quality top sites that may be used in some embodiments of the present invention include WIKIPEDIA, FACEBOOK, LINKEDIN, IMDB, and CLASSMATES. In embodiments, the search engine provider may manually identify web sites to be considered as high quality top sites.

In addition to identifying and indexing information regarding entities' homepages and entity web pages at high quality top sites, embodiments of the present invention discover and index information regarding other web pages that may be deemed highly relevant to entities based on search engine query logs. Further, information regarding variations of an entity's name as well as misspellings of an entity's name may be mined from web documents and/or search query logs and indexed.

The information mined from web documents and/or search engine query logs and indexed in the search system index as discussed above is referred to herein as “names metadata.” In accordance with embodiments of the present invention, names metadata is employed by a search engine to rank search results in response to name queries. When a search engine receives a search query, the search engine may analyze the search query to identify that the search query includes an entity's name and classify the search query as a name search query. Based on the classification of the search query as a name search query and identification of the entity's name, names metadata is employed in the process of identifying and ranking search results in response to the name search query. In particular, the names metadata improves the ranking of entity home pages, entity web pages from high quality top sites, and other entity-relevant web pages. In some embodiments, the names metadata is employed to build up a ranking model that facilitates such improved ranking. In some embodiments, the ranking model is built using a combination of a rules-based approach and a machine-learning approach.

Accordingly, in one aspect, an embodiment of the present invention is directed to one or more computer storage media storing computer-useable instructions that, when used by one or more computing devices, cause the one or more computing devices to perform a method. The method includes analyzing a URL using a plurality of heuristic rules. The method also includes identifying the URL as a homepage URL for an entity by identifying a name corresponding with the entity within the URL based on at least one of the heuristic rules. The method further includes indexing metadata in a search system index identifying the URL as a homepage URL corresponding with the entity.

In another embodiment, as aspect of the present invention is directed to one or more computer storage media storing computer-useable instructions that, when used by one or more computing devices, cause the one or more computing devices to perform a method. The method includes receiving a search query from an end user and identifying the search query as a name search query by recognizing that the search query includes an entity name. The method also includes, responsive to identifying the search query as a name search query, accessing a search system index that includes name metadata, the name metadata identifying a first URL as corresponding with a homepage for the entity and a second URL as corresponding with a web page for the entity at a high quality top site. The method further includes selecting and ranking search results for the search query based at least in part on the name metadata. The method still further includes providing the search results for presentation to the end user in response to the search query.

A further embodiment of the present invention is directed to one or more computer storage media storing computer-useable instructions that, when used by one or more computing devices, cause the one or more computing devices to perform a method. The method includes providing names metadata mined from web documents and search engine query logs and indexed in a search system index, the names metadata including metadata identifying a plurality of name-URL pairs, metadata identifying URLs as corresponding with homepages of entities, metadata identifying URLs as corresponding with entity web pages at high quality top sites, metadata based on search result click data, entity name equivalent data, and entity name misspelling data. The method also includes dividing the names metadata into three categories: a first category corresponding with entities' homepages, a second category corresponding with entity web pages at high quality top sites, and a third category corresponding with other entity-relevant web pages. The method further includes employing ranking rules and a neural net for each category to generate a score for each name-URL pair. The method still further includes training weights for each category.

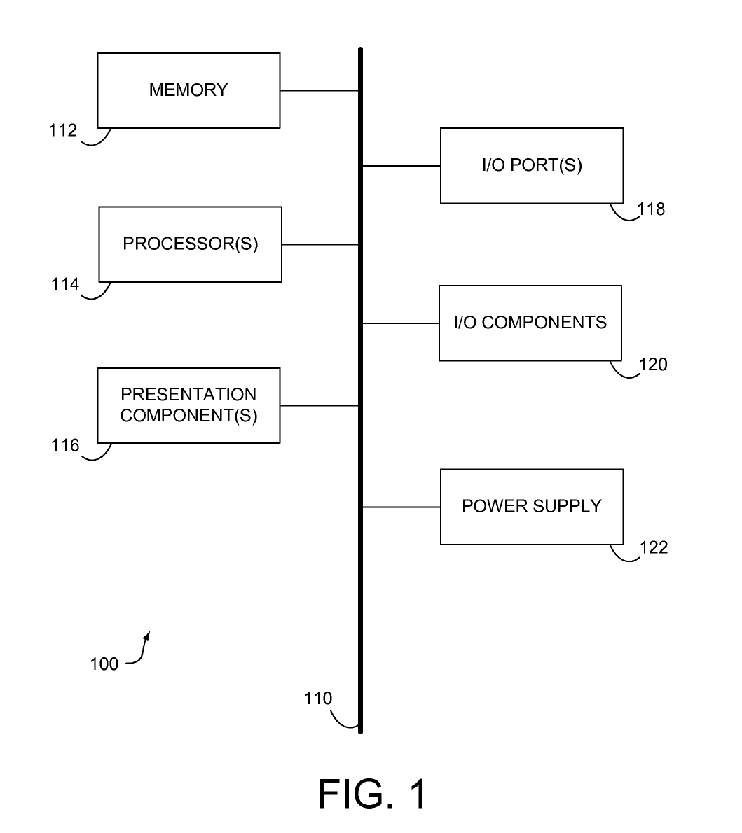

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

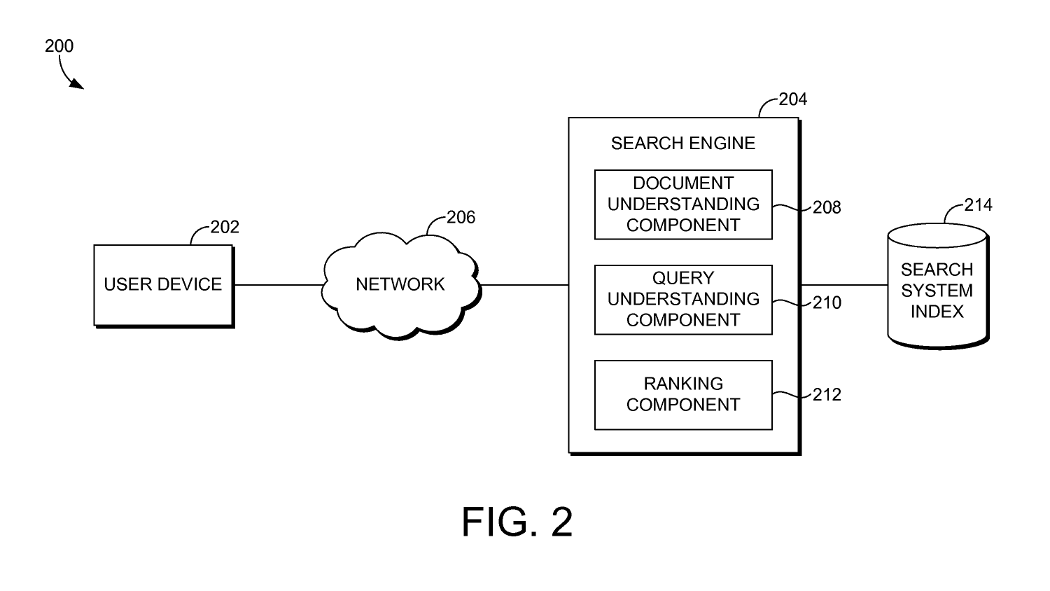

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a user device 202 and a search engine 204. Each of the components shown in FIG. 2 may be embodied on any type of computing device, such as computing device 100 described with reference to FIG. 1, for example. The components may communicate with each other via a network 206, which may include, without limitation, one or more local area networks (LANs) and/or wide area networks (WANs). Such networking environments are commonplace in offices, enterprise-wide computer networks, intranets, and the Internet. It should be understood that any number of user devices and search engines may be employed within the system 200 within the scope of the present invention. Each may comprise a single device or multiple devices cooperating in a distributed environment. For instance, the search engine 204 may comprise multiple devices arranged in a distributed environment that collectively provide the functionality described herein. Additionally, other components not shown may also be included within the system 200.

In accordance with embodiments of the present invention, a user may employ the user device 202 to submit search queries to the search engine 204 and, in response, receive a search results page with search results. For instance, the user may employ a web browser on the user device 202 to access a search input web page and enter a search query. As another example, the user may enter a search query via a search input box provided by a search engine toolbar located, for instance, within a web browser, the desktop of the user device 202, or other location. One skilled in the art will recognize that a variety of other approaches may also be employed for providing a search query within the scope of embodiments of the present invention.

At a high level, the search engine 204 can be viewed as including three main components as shown in FIG. 2. In particular, the search engine may include a document understanding component 208, a query understanding component 210, and a ranking component 210.

Initially, the document understanding component 208 generally operates to mine data from web documents and search engine query logs and to index names metadata based on the mined data in a search system index 214. As used herein, the term “names metadata” refers to information that facilitates identifying web documents that are relevant to particular entities to facilitate ranking search results to name search queries. In some embodiments, names metadata may include name-URL pairs, in which each name-URL pair specifies an entity's name and a URL of a web document corresponding with that entity as discovered by mining data from web documents and search engine query logs. In some instances, a name-URL pair may specify the URL as being a particular type of URL, such as a homepage URL or high quality top site URL, as will be described in further detail below. Other forms of names metadata may also be indexed in various embodiments of the present invention.

Names metadata may be mined from various portions of web pages, including URLs, titles, anchors, visual titles in web page content. Additionally, names metadata may be mined from search engine query logs, which store historical information regarding searches performed by end users on a search engine. The information may include search queries submitted by end users, search results provided in response to each search query, and/or search results selected by end users in response to each search query. A classifier built around entity names information may be used to mine the names metadata from these various sources.

In some embodiments, the document understanding component 208 operates to identify entities' homepages and index names metadata identifying the URLs of entities' homepages. As will be described in further detail below, a number of heuristics rules may be employed to analyze URLs to facilitate identifying URLs that are likely to be the homepages of entities. The heuristic rules use various combinations and extensions of name parts (e.g., first name, middle name, last name, etc.) to match URL domain parts.

If a URL is identified as an entity's homepage, names metadata is indexed to specify that the URL is a homepage URL for that entity. In some embodiments, the names metadata is a name-URL pair that specifies that the URL is a homepage URL for the entity named in the name-URL pair.

The document understanding component 208 may also operate to identify web pages for entities on high quality top sites. As noted above, a high quality top site comprises a website that is considered to provide high quality and reliable information regarding a number of entities. A high quality top site includes multiple web pages, each web page being directed to a particular entity or topic.

High quality top site often employ a URL pattern for web pages within the site. The URL pattern may dictate a location within the URL an entity's name appears and/or a format used for the entity's name. In some instances, high quality top sites may employ more than one URL pattern. In accordance with embodiments of the present invention, one or more URL patterns are identified for each high quality top site. Such patterns may be used to facilitate identifying entities associated with URLs.

When a URL at a high quality top site is identified as corresponding with a particular entity, names metadata is indexed to specify that the URL corresponds with a web page for that entity at the high quality top site. In some embodiments, the names metadata is a name-URL pair that specifies that the URL is a high quality top site URL for the entity named in the name-URL pair.

As noted above, the document understanding component 208 may also analyze search engine query logs to identify entity-relevant web pages. For instance, search engine query logs may be analyzed to identify name search queries and the entity named in each name search query. Additionally, web pages corresponding with search results that have been selected in response each name search query may also be identified. Web pages that have been selected in a sufficient number of searches for particular entities may be deemed to be relevant to those entities. Based on the analysis of the search engine query logs, information regarding entity-relevant web pages may be indexed.

The document understanding component 208 may further mine data regarding entity name equivalents and name misspellings. The data may be mined from web documents and/or search engine query logs. Additionally, the information may be accessed from a predefined nickname list. Such entity name equivalents and name misspellings data may also be indexed to facilitate providing relevant search results to name search queries.

When an end user submits a search query to the search engine 204, the query understanding component 210 may analyze the search query. The query understanding component 210 may determine that the search query comprises an entity's name and classify the search query as a name search query.

Based on the identification of the entity and classification of the search query as a name search query, the ranking component 212 performs a search to select and rank search results relevant to the entity. In embodiments, the ranking component 212 employs indexed names metadata from the search system index 214 to select and rank search results. By using the indexed names metadata, the entity's homepage, web pages directed to the entity at high quality top site, and other entity-related web pages are like to be highly ranked in the search result set.

Although embodiments of the present invention may employ any of a variety of different algorithms for selecting and ranking search results based on names metadata, some embodiments of the present invention build a ranking model using the names metadata and employ the ranking model to select and rank search results. In some embodiments, the ranking model is built using a combination of a rules-based approach and a machine-learning approach, as will be discussed in further detail below.

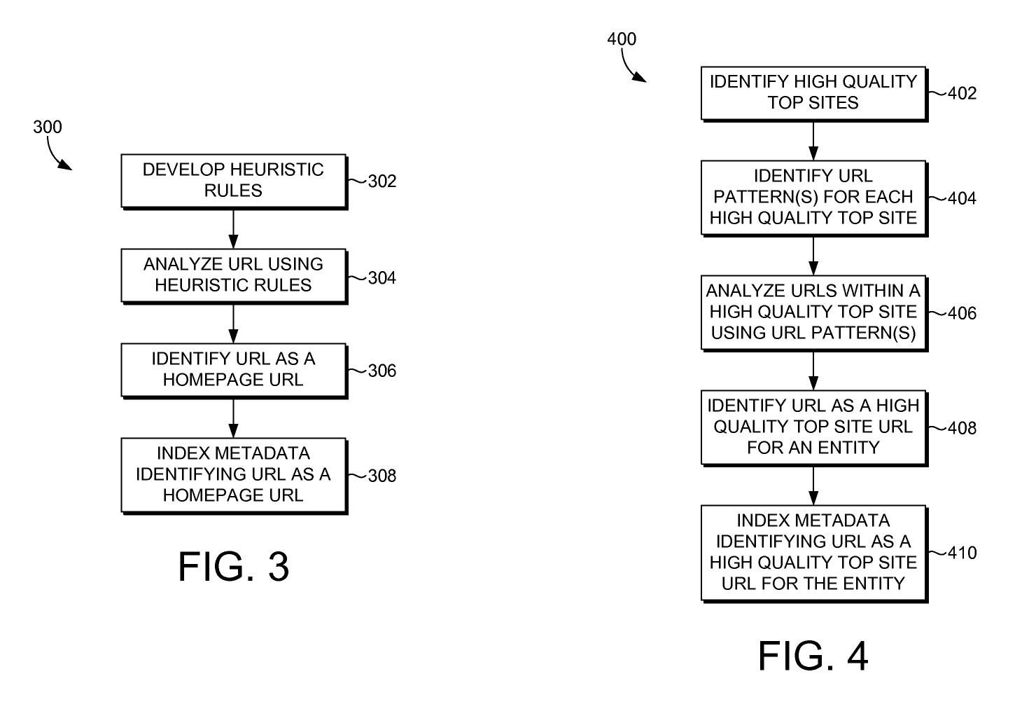

Turning to FIG. 3, a flow diagram is illustrated which shows a method 300 for identifying a URL as a homepage URL for an entity in accordance with an embodiment of the present invention. As shown at block 302, a number of heuristic rules are developed for analyzing URLs to facilitate identifying URLs that are likely to be the homepages of entities. The heuristic rules use various combinations and extensions of name parts (e.g., first name, middle name, last name, etc.) to match URL domain parts. By way of example only and not limitation, one heuristic rule may identify the combination of a first and last name within a URL domain part (e.g., Alan Ackles as www.alanackles.com). Another heuristic rule may identify the combination of a first, middle, and/or last name with punctuation, such as hyphens, within a URL domain part (e.g., Anne Sophie Mutter as www.anne-sophie-mutter.com). A further heuristic rule may identify the combination of an initial of a first name and a full last name within a URL domain part (e.g., James Roper as www.jroper.co.uk). As another example, a heuristic rule may identify the combination of an initial of first name with a full last name separated by punctuation within a URL domain part (e.g., Alex Perez as www.a-perez.com). It should be understood that the foregoing are provided as examples only. A large number of heuristic rules may be developed that rely on various combinations of names, name parts, name part abbreviations/initials, and punctuation in various embodiments of the present invention.

A URL is analyzed using the heuristic rules, as shown at block 304. In particular, the URL domain part is analyzed using the heuristic rules to determine if the domain part of the URL contains a name combination such that the URL should be identified as a URL homepage for an entity. Based on at least one heuristic rule, the URL is identified as a URL homepage for an entity corresponding with a particular name, as shown at block 306. For instance, the URL, www.alanackles.com, could be identified as the homepage URL for an entity (in this case, a person) corresponding with the name “Alan Ackles.”

Metadata is indexed to identify the URL as a homepage URL for an entity, as shown at block 308. The indexed metadata may indicate that the URL is a homepage URL and corresponds with a particular entity's name. In some embodiments, the indexed metadata may comprise a name-homepage URL pair that indicates the name of the entity and the URL of the entity's homepage. For instance, the indexed metadata may include the following name-homepage URL pair: name: “alan ackles”-> homepage: www.alanackles.com. A number of different approaches for indexing metadata for a homepage URL may be employed in various embodiments of the present invention.

Referring next to FIG. 4, a flow diagram is provided that illustrates a method 400 for identifying a URL for a web page for an entity at a high quality top site in accordance with an embodiment of the present invention. As shown at block 402, high quality top sites are initially identified. As discussed previously, a high quality top site is a web site that includes a number of web pages directed to different entities and topics and is considered to provide high quality and reliable information.

A URL pattern is identified for each high quality top site, as shown at block 404. Each website typically uses a particular pattern for URLs within the website. The pattern may dictate the location of the entity's name within the URL and/or a format for the entity's name (e.g., which name parts to include, how the parts are combined, whether punctuation is used, etc.). For instance, the URL for the web page for Charles Barley on the WIKIPEDIA website is en.wikipedia.org/wiki/Charles_Barkley. This demonstrates a pattern in which the entity's name appears after “en.wikipedia.org/wiki/” and the name is formed by combining the first and last name using an underscore between the names.

A high quality top site may employ more than one pattern in its URLs. For instance, a high quality top site may locate entity names' for different entities at different locations within the URLs. As another example, a high quality top site may use different name formats (e.g., which name parts to include, how the parts are combined, whether punctuation is used, etc.) for different entities. In some instances, a high quality top site may not use any specific name formats. As such, more than one pattern may be identified for a high quality top site at block 404. The patterns for a high quality top site may include any combination of location patterns and name formats. In instances in which a high quality top site does not use any specific name formats, heuristic rules such as those described above for home page identification may be used for analyzing entity names within URLs of the high quality top site.

URLs within a high quality top site are analyzed using the pattern(s) identified for that high quality top site, as shown at block 406. For instance, when analyzing a given URL, a location within the URL is identified based on the pattern for the high quality top site, and the text at that location is analyzed based on the name format identified based on the pattern for the high quality top site. As noted above, a URL may be analyzed using multiple known patterns for a high quality top site. Additionally, the analysis may include using heuristic rules, such as those described above for the homepage identification, for identifying an entity name within a URL.

Based on the analysis of a URL at a high quality top site at block 406, a URL is identified as corresponding with a given entity's name. As such, the URL is identified as a high quality top site URL for that entity name, as shown at block 408. Metadata identifying the URL as a high quality top site for the entity is indexed at block 410. The indexed metadata indicates that the URL is a page from a high quality top site and corresponds with a particular entity's name. In some embodiments, the indexed metadata may comprise a name-high quality top site URL pair that indicates the name of the entity and the URL of a web page for the entity at the high quality top site. For instance, the indexed metadata may include the following name-high quality top site URL pair: name: “charles barkley”-> names top site: en.wikipedia.org/wiki/Charles_Barkley. A number of different approaches for indexing metadata for a high quality top site URL may be employed in various embodiments of the present invention.

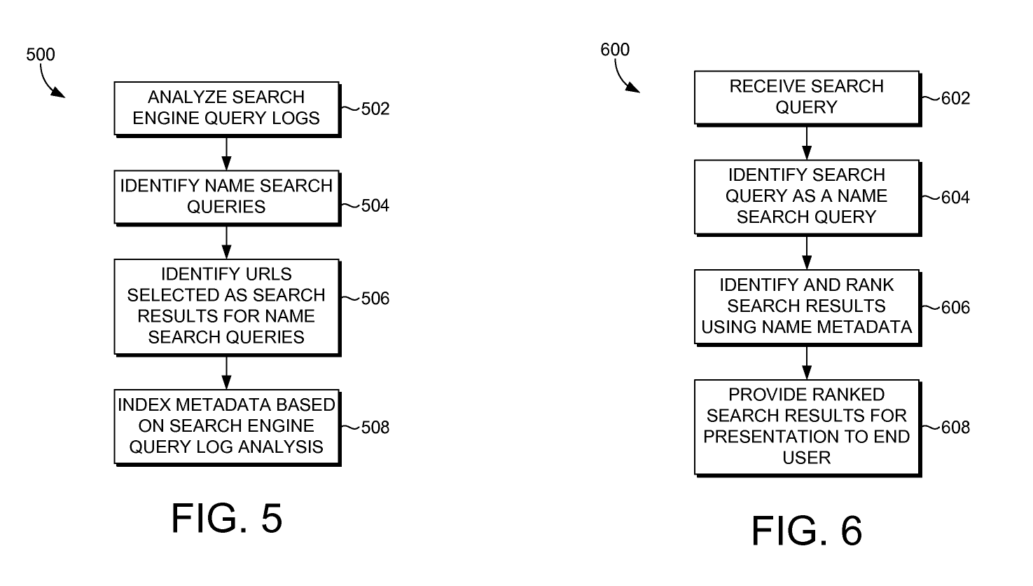

Turning to FIG. 5, a flow diagram is provided that illustrates a method 500 for using search engine query logs to identify web pages corresponding with entity names in accordance with an embodiment of the present invention. As shown at block 502, search engine query logs are analyzed. Based on the analysis, search queries that comprise name search queries are identified, as shown at block 504. Additionally, the process includes identifying URLs that were included as search results and were selected (“clicked on”) by end users in response to those identified name search queries, as shown at block 506.

Metadata is indexed at block 508 based on the analysis of the search engine query logs. In some instances, the metadata may identify web pages as corresponding with particular entity names based on the correlation between the names search queries and the URLs selected from search results for those names search queries. The indexed metadata may also include entity name equivalents data. For instance, a number of search queries that include variations of an entity's name may have each resulted in the selection of a given web page. Based on this information, the different names used in the search queries may be viewed as equivalents for the entity. The indexed metadata may also identify entity name misspellings. For instance, the search queries may include names that have been misspelled by the users entering the search queries. If the search queries resulted in selection of web pages that correspond with the entity, the misspellings from the search queries may be identified and metadata may be indexed to identify those misspellings for the entity's name.

Referring now to FIG. 6, a flow diagram is provided that illustrates a method 600 for performing a name segment search in accordance with an embodiment of the present invention. Initially, as shown at block 602, a search query is received. The search query is analyzed at block 604. Based on the analysis, an entity's name is identified in the search query, and the search query is classified as a name search query.

Responsive to classifying the search query as a name search query, a name segment search is performed. In particular, names metadata is employed to identify and rank search results, as shown at block 606. As discussed above, the names metadata may include information identifying the homepage for the entity, web pages regarding the entity at high quality top sites, other web pages relevant to the entity, as well as a variety of other metadata. A variety of different algorithms that employ the names metadata may be used to rank the search results. The ranked search results are provided for presentation to the end user in response to the search query, as shown at block 608.

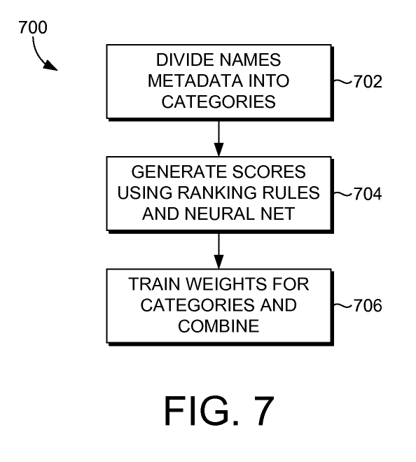

As mentioned previously, some embodiments of the present invention employ a ranking model developed using both a rules based approach and a machine learning approach. Accordingly, FIG. 7 provides a flow diagram showing a method 700 for building a ranking model in accordance with an embodiment of the present invention.

Initially, as shown at block 702, names metadata is divided into three categories: entities' homepages, entity web pages at high quality top sites, and other entity-relevant web pages. For each category, ranking rules from a rule-based approach and a neural net from a machine learning approach are used to generate a score for each name-URL pair, as shown at block 704. Both the rule-based approach and machine-learning approach treat the names metadata as a number of features. For instance, the names metadata features may include a homepage match feature, a high quality top site match feature, as well as a number of other features based on data mined and indexed as names metadata, as discussed hereinabove. In addition, indexed data other than names metadata may be used as features for building the ranking model, such as, for instance, static rank features, click features, and domain importance features.

For the rules-based approach, a predefined score is set for each feature. The score may be based on human priori knowledge and adjusted by offline experiments. A ranking score for each name-URL pair is determined based on the predefined scores for the various features. The machine-learning approach employs neural net training using the various features as inputs and providing a ranking score for each name-URL pair. As shown at block 706, an appropriate weight is trained for the three different categories and combined together. A ranking model developed using the method 700 may be employed to get ranked search results in response to name search queries.

As can be understood, embodiments of the present invention provide improved search results relevance for name search queries. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method comprising:
analyzing a URL using a plurality of heuristic rules;
identifying the URL as a homepage URL for an entity by identifying a name corresponding with the entity within the URL based on at least one of the heuristic rules; and
indexing metadata in a search system index identifying the URL as a homepage URL corresponding with the entity.

2. The one or more computer storage media of claim 1, wherein the metadata identifying the URL as the homepage URL for the entity comprises a name-URL pair comprising the name of the entity and an identification of the URL corresponding with a homepage for the entity.

3. The one or more computer storage media of claim 1, wherein the method further comprises:
receiving a search query from an end user;
identifying the name of the entity in the search query and classifying the search query as a name search query;
responsive to classifying the search query as a name search query, using the indexed metadata to improve the ranking of a search result corresponding with the URL identified as the homepage URL for the entity; and
providing a plurality of search results for presentation to the end user, the plurality of search results including the search result corresponding with the URL identified as the homepage URL for the entity.

4. The one or more computer storage media of claim 1, wherein the method further comprises:
analyzing a second URL at a high quality top site using a known URL pattern for the high quality top site;
identifying the name of the entity in the second URL based on the known URL pattern for the high quality top site; and
indexing metadata in the search system index identifying the second URL as corresponding with a web page for the entity at the high quality top site.

5. The one or more computer storage media of claim 4, wherein the known URL pattern identifies a location within the second URL for identifying the name of the entity.

6. The one or more computer storage media of claim 4, wherein the known URL pattern identifies a name format.

7. The one or more computer storage media of claim 4, wherein the name of the entity is identified in the second URL using at least one heuristic rule in addition to the known URL pattern for the high quality top site.

8. The one or more computer storage media of claim 4, wherein the metadata identifying the second URL as corresponding with a web page for the entity at the high quality top site comprises a second name-URL pair comprising the name of the entity and an identification of the second URL as corresponding with a web page for the entity at the high quality top site.

9. The one or more computer storage media of claim 1, wherein the method further comprises:
analyzing search engine query logs;
identifying a name search query within the search engine query logs that contains the name of the entity;
identifying a second URL selected from search results returned for the name search query; and
indexing metadata identifying the second URL as corresponding with a web page relevant to the entity.

10. The one or more computer storage media of claim 9, wherein the metadata is indexed based on identifying the second URL as being selected in response to a plurality of name search queries containing the name of the entity.

11. The one or more computer storage media of claim 9, wherein the metadata identifying the second URL as corresponding with a web page relevant to the entity comprises a second name-URL pair comprising the name of the entity and an identification of the second URL as corresponding with a web page relevant to the entity.

12. One or more computer storage media storing computer-useable instructions that, when used by one or more computing devices, cause the one or more computing devices to perform a method comprising:
receiving a search query from an end user;
identifying the search query as a name search query by recognizing that the search query includes an entity name;
responsive to identifying the search query as a name search query, accessing a search system index that includes name metadata, the name metadata identifying a first URL as corresponding with a homepage for the entity and a second URL as corresponding with a web page for the entity at a high quality top site;
selecting and ranking search results for the search query based at least in part on the name metadata; and
providing the search results for presentation to the end user in response to the search query.

13. The one or more computer storage media of claim 12, wherein the name metadata includes a plurality of name-URL pairs, each name-URL pair indicating a name of an entity and a URL of a web page relevant to the entity.

14. The one or more computer storage media of claim 12, wherein the name metadata identifying the first URL as corresponding with the homepage for the entity was identified by analyzing the first URL using a plurality of heuristic rules.

15. The one or more computer storage media of claim 12, wherein the name metadata identifying the second URL as corresponding with the web page for the entity at the high quality top site was identified by analyzing the second URL using known URL pattern for the high quality top site.

16. The one or more computer storage media of claim 12, wherein the name metadata further comprises entity equivalents metadata specifying alternative names for the entity.

17. The one or more computer storage media of claim 12, wherein the name metadata further comprises misspellings metadata specifying misspellings of the entity name.

18. The one or more computer storage media of claim 12, wherein the search results are selected and ranked using a ranking model developed using the names metadata.

19. The one or more computer storage media of claim 18, wherein the ranking model was developed using the names metadata by employing both a rules-based approach and a machine-leaning approach.

20. One or more computer storage media storing computer-useable instructions that, when used by one or more computing devices, cause the one or more computing devices to perform a method comprising:
providing names metadata mined from web documents and search engine query logs and indexed in a search system index, the names metadata including metadata identifying a plurality of name-URL pairs, metadata identifying URLs as corresponding with homepages of entities, metadata identifying URLs as corresponding with entity web pages at high quality top sites, metadata based on search result click data, entity name equivalent data, and entity name misspelling data;
dividing the names metadata into three categories: a first category corresponding with entities' homepages, a second category corresponding with entity web pages at high quality top sites, and a third category corresponding with other entity-relevant web pages;
employing ranking rules and a neural net for each category to generate a score for each name-URL pair; and
training weights for each category.
